(19) United States
(12) Patent Application Publication
(10) Pub. No.: US 2026/0012931 A1
(43) Pub. Date: Jan. 8, 2026

(54) METHOD FOR RESOURCE SELECTION BASED ON INTER-TERMINAL COORDINATION, AND TERMINAL DEVICES THEREOF

(71) Applicant: GUANGDONG OPPO MOBILE TELECOMMUNICATIONS CORP., LTD., Dongguan (CN)

(72) Inventors: Yi DING, Dongguan (CN); Zhenshan ZHAO, Dongguan (CN)

(21) Appl. No.: 19/327,553

(22) Filed: Sep. 12, 2025

Related U.S. Application Data
(63) Continuation of application No. PCT/CN2023/081706, filed on Mar. 15, 2023.

(51) Int. Cl. H04W 72/02; H04W 72/25; H04W 72/542

(52) U.S. Cl. CPC H04W 72/02; H04W 72/25; H04W 72/542

(57) ABSTRACT

Provided is a method for resource selection based on inter-terminal coordination. The method is performed by a first terminal device, and includes: determining a resource set based on a spatial-domain transmission filter, and transmitting first information to a second terminal device, wherein the first information is used to indicate the resource set.

### CROSS-REFERENCE TO RELATED APPLICATION

This application is a continuation application of international application No. PCT/CN2023/081706, filed on Mar. 15, 2023, the entire contents of which are incorporated herein by reference.

### TECHNICAL FIELD

Embodiments of the present disclosure relate to the field of communication technologies, and in particular, relate to a method for resource selection based on inter-terminal coordination, and terminal devices thereof.

### RELATED ART

In sidelink (SL) communications, a method for resource selection based on inter-terminal coordination has been provided for an SL communication method in which a terminal device independently selects resources through sensing.

### SUMMARY

Embodiments of the present disclosure provide a method for resource selection based on inter-terminal coordination, and terminal devices thereof. The technical solutions are as follows.

In some embodiments of the present disclosure, a method for resource selection based on inter-terminal coordination is provided. The method is performed by a first terminal device, and includes:
determining a resource set based on a spatial-domain transmission filter; and
transmitting first information to a second terminal device, wherein the first information is used to indicate the resource set.

In some embodiments of the present disclosure, a terminal device is provided. The terminal device includes: a processor and a memory storing one or more computer programs, wherein the processor is configured to load and run the one or more computer programs to cause the terminal device to: determine a resource set based on a spatial-domain transmission filter; and transmit first information to a second terminal device, wherein the first information is used to indicate the resource set.

In some embodiments of the present disclosure, a terminal device is provided. The terminal device includes: a processor and a memory storing one or more computer programs, wherein the processor is configured to load and run the one or more computer programs to cause the terminal device to: receive first information from a first terminal device, wherein the first information is used to indicate a resource set determined by the first terminal device based on a spatial-domain transmission filter; and determine a transmission resource based on the resource set.

### BRIEF DESCRIPTION OF DRAWINGS

FIG. 1 is a schematic diagram of a network architecture according to some embodiments of the present disclosure;

FIG. 2 is a schematic diagram of a physical layer structure in SL communication according to some embodiments of the present disclosure;

FIG. 3 is a schematic diagram of reservation of time-frequency resource positions according to some embodiments of the present disclosure;

FIG. 4 is a schematic diagram of resource sensing and resource selection according to some embodiments of the present disclosure;

FIG. 5 is a schematic diagram illustrating a system without beamforming and a system with beamforming according to some embodiments of the present disclosure;

FIG. 6 is a flowchart of a method for resource selection based on inter-terminal coordination according to some embodiments of the present disclosure;

FIG. 7 is a schematic diagram of a method for resource selection based on inter-terminal coordination according to some embodiments of the present disclosure;

FIG. 8 is a schematic diagram of a method for resource selection based on inter-terminal coordination according to some embodiments of the present disclosure;

FIG. 9 is a flowchart of a method for resource selection based on inter-terminal coordination according to some embodiments of the present disclosure;

FIG. 10 is a schematic diagram of a method for resource selection based on inter-terminal coordination according to some embodiments of the present disclosure;

FIG. 11 is a flowchart of a method for resource selection based on inter-terminal coordination according to some embodiments of the present disclosure;

FIG. 12 is a schematic diagram of a correspondence between inter-terminal receiver beams and transmit beams according to some embodiments of the present disclosure;

FIG. 13 is a schematic diagram of a correspondence between inter-terminal receiver beams and transmit beams according to some embodiments of the present disclosure;

FIG. 14 is a flowchart of a method for resource selection based on inter-terminal coordination according to some embodiments of the present disclosure;

FIG. 15 is a schematic diagram of a method for resource selection based on inter-terminal coordination according to some embodiments of the present disclosure;

FIG. 16 is a block diagram of an apparatus for resource selection based on inter-terminal coordination according to some embodiments of the present disclosure;

FIG. 17 is a block diagram of an apparatus for resource selection based on inter-terminal coordination according to some embodiments of the present disclosure;

FIG. 18 is a block diagram of an apparatus for resource selection based on inter-terminal coordination according to some embodiments of the present disclosure;

FIG. 19 is a block diagram of an apparatus for resource selection based on inter-terminal coordination according to some embodiments of the present disclosure; and

FIG. 20 is a schematic structural diagram of a terminal device according to some embodiments of the present disclosure.

### DETAILED DESCRIPTION

For clearer descriptions of the objectives, technical solutions, and advantages of the present disclosure, embodiments of the present disclosure are further described in detail hereinafter with reference to the accompanying drawings.

The network architecture and service scenarios described in the embodiments of the present disclosure are intended to describe the technical solutions according to the embodiments of the present disclosure more clearly, but do not constitute any limitation on the technical solutions according to the embodiments of the present disclosure. Those of ordinary skilled in the art understand that, with the evolution of the network architecture and the emergence of new service scenarios, the technical solutions according to the embodiments of the present disclosure are also applicable to similar technical problems.

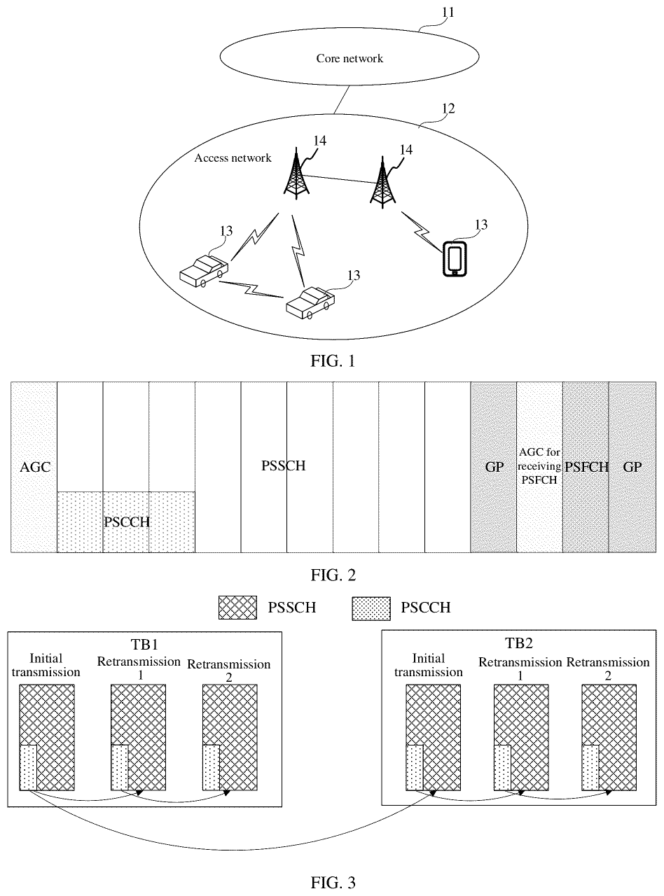

Referring to FIG. 1, a schematic diagram of a network architecture according to some embodiments of the present disclosure is illustrated. The network architecture includes: a core network 11, an access network 12, and terminal devices 13.

The core network 11 includes a plurality of core network devices. The core network devices mainly function to provide user connection, user management, and service bearing, and serve as a bearer network to provide an interface to an external network. For example, the core network of a 5-th generation mobile communication (5G) new radio (NR) system includes devices such as an access and mobility management function (AMF) entity, a user plane function (UPF) entity, and a session management function (SMF) entity.

The access network 12 includes a plurality of access network devices 14. The access network in the 5G NR system may be referred to as a new generation-radio access network (NG-RAN). The access network devices 14 refer to apparatuses deployed in the access network 12 to provide wireless communication functionality for the terminal devices 13. The access network device 14 includes various forms of macro base stations, micro base stations, relay stations, access points, and the like. The name of the device with functionality of an access network device varies in systems employing different radio access technologies. For example, the device is referred to as a gNodeB or a gNB in the 5G NR system. With the evolution of communication technologies, the name “access network device” may change. For the convenience of description, the above apparatuses providing the wireless communication functionality for the terminal devices 13 are collectively referred to as the access network device in the embodiments of the present disclosure.

Typically, a plurality of terminal devices 13 are provided, and one or more terminal devices 13 may be arranged in a cell managed by each of the access network devices 14. The terminal devices 13 may include various handheld devices, in-vehicle devices, wearable devices, computing devices, other processing devices connected to a radio modem with the wireless communication functionality, various forms of user equipments (UEs), mobile stations (MS), and the like. For convenience of description, the devices described above are collectively referred to as the terminal devices. The access network devices 14 communicate with the core network devices using an air interface technology, such as an NG interface in the 5G NR system. The access network devices 14 communicate with the terminal devices 13 using an air interface technology, such as a Uu interface. The “terminal device” in the embodiments of the present disclosure is also referred to as the UE, which have the same meaning.

The terminal devices 13 (for example, the in-vehicle device and another device, such as another in-vehicle device, a mobile phone, or a road side unit (RSU)) may communicate with each other over a direct communication interface (for example, a PC5 interface). Accordingly, the communication link established based on the direct communication interface may be referred to as a direct link or an SL. The SL transmission means that data transmission is directly carried out between the terminal devices over an SL, which is different from a conventional cellular system in which the communication data is received or transmitted by the access network device. The SL transmission has characteristics of short delay and low overhead, and is therefore suitable for communication between two terminal devices that are geographically close to each other (such as an in-vehicle device and another peripheral device that is geographically close to the in-vehicle device). It should be noted that, in FIG. 1, only vehicle-to-vehicle communication in a vehicle-to-everything (V2X) scenario is illustrated, while the SL communication is applicable to various scenarios where terminal devices directly communicate with each other. In other words, the terminal device in the present disclosure refers to any device that communicates with another device over the SL.

The “5G NR system” in the embodiments of the present disclosure may also be referred to as a 5G system or an NR system, but those skilled in the art can understand the meaning thereof. The technical solutions according to the embodiments of the present disclosure are applicable to the 5G NR system, and also to evolved systems of the 5G NR system.

Before description of the technical solutions of the present disclosure, some background technical knowledge involved in the present disclosure is first explained. The following related technologies may be combined with the technical solutions according to the embodiments of the present disclosure in any manner, all of which fall within the scope of protection of the embodiments of the present disclosure. The embodiments of the present disclosure include at least some of the following content.

### 1. SL Transmission

Regarding the SL transmission, the third Generation Partnership Project (3GPP) has defined two transmission modes: a mode A and a mode B.

In the mode A, transmission resources of the terminal device are allocated by an access network device (such as a base station). The terminal device transmits communication data over the sidelink based on the transmission resources allocated by the access network device. The access network device may allocate transmission resources to the terminal device for single transmission, or allocate transmission resources to the terminal device for semi-static transmission.

In the mode B, the terminal device selects transmission resources from a resource pool autonomously for the transmission of communication data. Specifically, the terminal device may select transmission resources from the resource pool either by sensing or by random selection.

Next, SL communication in NR V2X systems where the terminal device autonomously selects resources (i.e., the mode B described above) is mainly described.

### 2. NR V2X Physical Layer Structure

A physical layer structure of SL communication in the NR V2X system is illustrated in FIG. 2. The first symbol in the slot illustrated in FIG. 2 is an AGC symbol. In a case where an SL UE receives data, a receive power is adjusted to a power suitable for demodulation in the symbol. In a case where the SL UE transmits data, content of a next symbol of the symbol is repeatedly transmitted on the AGC symbol. In FIG. 2, a physical sidelink control channel (PSCCH) is configured to bear first-stage sidelink control information, and a physical sidelink shared channel (PSSCH) is configured to bear data and second-stage sidelink control information. The PSCCH and the PSSCH are transmitted in the same slot. The first sidelink control information and the second sidelink control information may be two pieces of sidelink control information having different functions. For example, the first sidelink control information is carried in the PSCCH and mainly includes fields related to resource sensing, thereby facilitating other terminal devices to perform resource exclusion and resource selection upon decoding. In the PSSCH, the second sidelink control information is further carried in addition to data, and mainly includes fields related to data demodulation, thereby facilitating other terminal devices to demodulate the data in the PSSCH. A slot may include a symbol corresponding to a physical sidelink feedback channel (PSFCH). The PSFCH is configured to transmit hybrid automatic repeat request (HARQ) feedback information. Depending on configuration of the resource pool, the symbol corresponding to the PSFCH occurs once every one, two, and four slots. In a case where a slot does not include the symbol corresponding to the PSFCH, for example, a guard period (GP) (that is, a GAP) symbol between the PSSCH and the PSFCH, the AGC for receiving the PSFCH, and a PSFCH symbol in FIG. 2 are all configured to carry the PSSCH. In general, a last symbol in the slot is the GP symbol, that is, GAP. Alternatively, a symbol subsequent to the last symbol carrying the PSSCH or the PSFCH is the GP symbol. The SL UE performs reception-transmission conversion within the GP symbol, but does not transmit data. In a case where a slot includes a PSFCH resource, a GP symbol is present between the PSSCH and the PSFCH symbols. This is because the UE transmits data over the PSSCH and receives data over the PSFCH, and the GP symbols is required for reception-transmission conversion.

### 3. Resource Reservation in NR V2X

In the NR V2X system, in the mode B, the terminal device selects transmission resources autonomously for data transmission. Resource reservation is a prerequisite for resource selection.

The resource reservation means that the terminal device transmits the first sidelink control information in the PSCCH to reserve resources to be used. The NR V2X system supports both intra-transport block (TB) resource reservation and inter-TB resource reservation.

As illustrated in FIG. 3, the terminal device transmits the first sidelink control information, and indicates N time-frequency resources (including a resource for current data transmission) of a current TB by using the Time Resource Assignment and Frequency Resource Assignment fields in the first sidelink control information. N≤Nmax, and Nmax is equal to 2 or 3 in NR V2X. Meanwhile, the N indicated time-frequency resources should be arranged in W slots. W is equal to 32 in NR V2X. In the TB1 illustrated in FIG. 3, the terminal device transmits the first sidelink control information in the PSCCH while transmitting initial transmission data in the PSSCH, and indicates time-frequency resource positions for initial transmission and retransmission 1 (i.e., N=2) using the two fields described above. That is, a time-frequency resource for retransmission 1 is reserved. Moreover, initial transmission and retransmission 1 are arranged and carried out across 32 slots in a time domain. Similarly, in the TB1 illustrated in FIG. 3, the terminal device indicates time-frequency resource positions for retransmission 1 and retransmission 2 using the first sidelink control information transmitted in the PSCCH of retransmission 1, and retransmission 1 and retransmission 2 are arranged and carried out across 32 slots in the time domain.

Besides, in transmitting the first sidelink control information, the terminal device performs the inter-TB resource reservation using a Resource Reservation Period field. For example, in FIG. 3, in transmitting the first sidelink control information of initial transmission of the TB1, the terminal device indicates time-frequency resource positions for initial transmission and retransmission 1 of the TB1 using the Time Resource Assignment and Frequency Resource Assignment fields, which are denoted as {(t₁, f₁), (t₂, f₂)}. t₁ and t₂ represent the time domain positions of initial transmission and retransmission 1 resources of the TB1, and f₁ and f₂ represent the corresponding frequency domain positions. In a case where a value of the Resource Reservation Period field in the first sidelink control information is 100 ms, the sidelink control information (SCI) simultaneously indicates the time-frequency resources {(t₁+100, f₁), (t₂+100, f₂)}. The two resources are used for the initial transmission and the retransmission 1 of TB2. Similarly, the first sidelink control information transmitted in retransmission 1 of the TB1 also reserves time-frequency resources for retransmission 1 and retransmission 2 of the TB2 using the Resource Reservation Period field. In NR V2X, possible values for the Resource Reservation Period field are 0, 1-99, 100, 200, 300, 400, 500, 600, 700, 800, 900, and 1000 ms, offering greater flexibility compared to LTE V2X. However, only e values are configured in each resource pool, and the terminal device determines a possible value to be used based on the used resource pool. The e values in the resource pool configuration are denoted as a resource reservation period set M, and exemplarily, e is less than or equal to 16.

In addition, the inter-TB reservation may be activated or deactivated on a resource pool basis by means of network configuration or pre-configuration. In a case where the inter-TB reservation is activated, the first sidelink control information includes the Resource Reservation Period field. In a case where the inter-TB reservation is deactivated, the first sidelink control information does not include the Resource Reservation Period field. In a case where the inter-TB reservation is activated, the value of the Resource Reservation Period field used by the terminal device, i.e., the resource reservation period, is generally not changed prior to trigger of resource reselection. The terminal device reserves resources for a next period using the Resource Reservation Period field in the first sidelink control information for transmission of another TB each time the terminal device transmits the first sidelink control information, such that periodic semi-persistent transmission is achieved.

In a case where the terminal device operates in the mode B, the terminal device acquires, by sensing the PSCCHs from another terminal device, the first sidelink control information transmitted by the another terminal device to acknowledge the resources reserved by another terminal device. In resource selection, the terminal device excludes the resources reserved by the another terminal device to avoid resource collision.

### 4. Resource Selection Method for NR V2X Sensing

In the NR V2X system, the terminal device needs to select resources autonomously in the mode B.

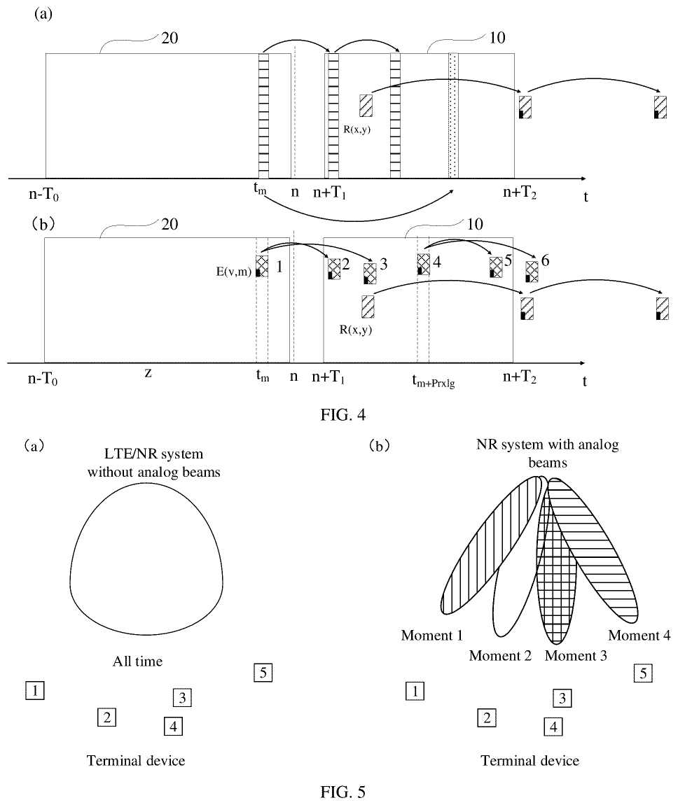

As illustrated in FIG. 4, the terminal device triggers resource selection or reselection in a slot n, or the slot n is a slot where a higher layer triggers a physical layer to report a candidate resource set. A resource selection window 10 starts from n+T1 and ends at n+T2. 0≤T1≤Tproc,1, and Tproc,1 represents 3, 5, 9, or 17 slots in a case where the subcarrier spacing is 15, 30, 60, or 120 kHz. T2 min≤T2≤a remaining delay budget of services, and a value set of T2 min is {1, 5, 10, 20} *2μ slots. μ=0, 1, 2, or 3, which correspond to the subcarrier spacing being 15, 30, 60, or 120 kHz respectively. The terminal device determines T2 min from the value set based on a priority of its own to-be-transmitted data. For example, in a case where the subcarrier spacing is 15 kHz, the terminal device determines T2 min from the set {1, 5, 10, 20} based on the priority of its own to-be-transmitted data. In a case where T2 min is greater than or equal to the remaining delay budget of service, T2 is equal to the remaining delay budget of service. The remaining delay budget means a difference between a corresponding time of a delay requirement of the data and a current time. For example, for a packet arriving in the slot n, the delay requirement is 50 ms. Assuming that least one slot is 1 ms, then the remaining delay budget is 50 ms in a case where the current time is the slot n, and the remaining delay budget is 30 ms in a case where the current time is a slot n+20.

The terminal device senses resources from n-TO to n-Tproc,0 (excluding n-T_{proc,0}), and a value of TO is 100 or 1100 ms. In a case where the subcarrier spacing is 15, 30, 60, or 120 kHz, T_{proc,0} represents 1, 1, 2, or 4 slots. In some embodiments, the terminal device senses resources in a slot that is within a resource pool used by the terminal device within a resource sensing window. In some embodiments, the terminal device senses the first sidelink control information transmitted by another terminal device in each slot (except for its own transmission slot), and the terminal device uses the results of resource sensing in n-T0 to n-Tproc,0 upon trigger of resource selection or reselection in the slot n.

In step 1, the terminal device determines all available resources within the resource pool used by the terminal device in the resource selection window 10 as a resource set A, and any of the resources in the set A is denoted as the resource R(x, y). x and y respectively represent a frequency domain position and a time domain position of the resource. An initial number of the resources in the set A is denoted as Mtotal. The terminal device excludes resources in the resource set A based on an unmonitored slot in the resource sensing window 20 (step 1-1) and/or resource sensing results in the resource sensing window 20 (step 1-2). The terminal device determines whether the resource R(x, y) or a series of periodic resources corresponding to the resource R(x, y) are overlapped with a slot determined based on the unmonitored slot in step 1-1 or a resource determined based on the sensed first sidelink control information in step 1-2, and excludes the resource R(x, y) from the resource set A in a case where these resources are overlapped with each other.

In step 1-1, in a case where the terminal device transmits data in the slot tm within the resource sensing window 20 but does not carry out sensing, the terminal device determines corresponding Q slots based on the slot tm and each allowed resource reservation period in the resource pool used by the terminal device, with the resource reservation period as an interval. In a case where the Q slots are overlapped with the resource R(x, y) or the series of periodic resources corresponding to the resource R(x, y), the resource R(x, y) is excluded from the resource set A. Q=1 or Q=[Tscal/Prx] (for rounding up). Tscal is equal to a value of T2 converted into milliseconds. Prx represents one of the resource reservation periods allowed by the resource pool used by the terminal device. In some embodiments, a series of periodic resources corresponding to the resource R(x, y) are R(x, y+j*Ptxlg), j=0, 1, 2, . . . , Cresel−1. Cresel is related to a random count value generated by the terminal device, and Ptxlg represents the number of logical slots converted from Ptx. Ptx represents the resource reservation period of the terminal device. For example, the case that Cresel is equal to 3 in FIG. 4(a) means three periodic resources corresponding to the resource R(x, y) (including the resource R(x, y)).

For example, in FIG. 4(a), the terminal device does not carry out sensing in the slot tm, but performs resource exclusion in sequence based on each resource reservation period in the resource reservation period set M in the used resource pool configuration. For a resource reservation period 1, assuming that the Q value is calculated as 2, then the corresponding Q slots are two subsequent slots mapped from the slot tm in FIG. 4(a) as indicated by a horizontal line shadow, with the resource reservation period 1 as an interval. For a resource reservation period 2, assuming that the Q value is calculated as 1, then the corresponding Q slots are one subsequent slot mapped from the slot tm in FIG. 4(a) as indicated by a dotted shadow, having the resource reservation period 2 as an interval.

The terminal device determines whether Q slots corresponding to each reservation period are overlapped with the resource R(x, y) or a series of periodic resources corresponding to the resource R(x, y), and excludes the resource R(x, y) from the resource set A in a case where these resources are overlapped with each other.

In some embodiments, in a case where the inter-TB reservation is deactivated for the resource pool used by the terminal device, the terminal device does not perform step 1-1.

In some embodiments, upon completion of step 1-1, in a case where the number of remaining resources in the resource set A is less than Mtotal*X, the resource set A is initialized into all available resources within the resource pool used by the terminal device in the resource selection window 10, and then step 1-2 is performed.

In step 1-2, in a case where the terminal device senses the first sidelink control information transmitted in the PSCCH within the slot tm of the resource sensing window 20, a sidelink reference signal received power (SL-RSRP) of the PSCCH or an SL-RSRP of the PSSCH scheduled by the PSCCH (that is, the SL-RSRP of the PSCCH transmitted in the same slot as the PSCCH) is measured.

In a case where the measured SL-RSRP is greater than an SL-RSRP threshold and the first sidelink control information received by the terminal device includes the Resource Reservation Period field, the terminal device determines the corresponding Q slots based on the slot tm and the resource reservation period carried in the sensed first sidelink control information, with the resource reservation period as an interval. The terminal device assumes that the first sidelink control information with the same content is received in the Q slots. The terminal device determines whether the resources indicated in the Time Resource Assignment and Frequency Resource Assignment fields of the first sidelink control information received in the slot tm and the Q pieces of the first sidelink control information assumed to be received are overlapped with the resource R(x, y) or a series of periodic resources corresponding to the resource R(x, y), and excludes the corresponding resource R(x, y) from the set A in a case where these resources are overlapped with each other. Q=1 or Q=[Tscal/Prx] (for rounding up). Tscal is equal to a value of T2 converted into milliseconds. Prx represents the resource reservation period carried in the sensed first sidelink control information. In some embodiments, a series of periodic resources corresponding to the resource R(x, y) are R(x, y+j*Ptxlg), j=0, 1, 2, . . . , Cresel−1. Cresel is related to a random count value generated by the terminal device, and Ptxlg represents the number of logical slots converted from Ptx. Ptx represents the resource reservation period of the terminal device, for example, the case that the Cresel is equal to 3 in FIG. 4(b) means three periodic resources corresponding to the resource R(x, y) (including the resource R(x, y)).

For example, in FIG. 4(b), in a case where the first sidelink control information received by the terminal device includes the Resource Reservation Period field, the terminal device senses the first sidelink control information in the PSCCH in the slot tm resource E(v, m), having the resource reservation period in the field being Prx. Assuming that the Q value is calculated as 1, then the terminal device assumes that the first sidelink control information with the same content is also received in the slot tm+Prxlg. The terminal device determines whether the resources 1, 2, 3, 4, 5, and 6 indicated in the Time Resource Assignment and Frequency Resource Assignment fields of the first sidelink control information received in the slot tm and the first sidelink control information assumed to be received in the slot tm+Prxlg are overlapped with the resource R(x, y) or a series of periodic resources corresponding to the resource R(x, y), and excludes the resource R(x, y) from the resource set A in a case where these resources are overlapped with each other and the RSRP condition is met.

In a case where the SL-RSRP measured by the terminal device is greater than the SL-RSRP threshold and the first sidelink control information received by the terminal device does not include the Resource Reservation Period field, the terminal device only determines whether the resource indicated in the Time Resource Assignment and Frequency Resource Assignment fields of the first sidelink control information received in the slot tm is overlapped with the resource R(x, y) or a series of resources corresponding to the resource R(x, y), and excludes the resource R(x, y) from the resource set A in a case where these resources are overlapped with each other.

For example, in FIG. 4(b), in a case where the first sidelink control information received by the terminal device does not include the Resource Reservation Period field, and the terminal device senses the first sidelink control information in the PSCCH in the slot tm resource E(v, m), the terminal device determines whether the resources 1, 2, and 3 indicated in the Time Resource Assignment and Frequency Resource Assignment fields in the first sidelink control information are overlapped with the resource R(x, y) or a series of periodic resources corresponding to the resource R(x, y), and excludes the resource R(x, y) from the resource set A in a case where these resources are overlapped with each other and the RSRP condition is met.

In a case where the number of the remaining resources in the resource set A upon the resource exclusion is less than Mtotal*X, the SL-RSRP threshold is raised by 3 dB, and step 1 is performed again. The physical layer reports the resource set A upon resource exclusion to a higher layer as a candidate resource set.

In step 2, the higher layer randomly selects resources from the reported candidate resource set for data transmission. That is, the terminal device randomly selects resources from the candidate resource set for data transmission.

It should be noted that:

(1). The RSRP threshold is determined based on the priority P1 carried in the PSCCH sensed by the terminal device and the priority P2 of the data to be transmitted by the terminal device. The configuration of the resource pool used by the terminal device includes an SL-RSRP threshold table, and the SL-RSRP threshold table includes SL-RSRP thresholds corresponding to all priority combinations. The resource pool may be configured on the network or preconfigured.

For example, as listed in Table 1, it is assumed that the selectable values of the priority levels of both P1 and P2 are 0 to 7, the SL-RSRP thresholds corresponding to different priority combinations are represented by yij. In yij, i is a value of the priority level P1, and j is a value of the priority level P2.

TABLE 1
SL-RSRP threshold table

P2

| P1 | 0 | 1 | 2 | 3 | 4 | 5 | 6 | 7 |
|---|---|---|---|---|---|---|---|---|
| 0 | γ₀₀ | γ₀₁ | γ₀₂ | γ₀₃ | γ₀₄ | γ₀₅ | γ₀₆ | γ₀₇ |
| 1 | γ₁₀ | γ₁₁ | γ₁₂ | γ₁₃ | γ₁₄ | γ₁₅ | γ₁₆ | γ₁₇ |
| 2 | γ₂₀ | γ₂₁ | γ₂₂ | γ₂₃ | γ₂₄ | γ₂₅ | γ₂₆ | γ₂₇ |
| 3 | γ₃₀ | γ₃₁ | γ₃₂ | γ₃₃ | γ₃₄ | γ₃₅ | γ₃₆ | γ₃₇ |
| 4 | γ₄₀ | γ₄₁ | γ₄₂ | γ₄₃ | γ₄₄ | γ₄₅ | γ₄₆ | γ₄₇ |
| 5 | γ₅₀ | γ₅₁ | γ₅₂ | γ₅₃ | γ₅₄ | γ₅₅ | γ₅₆ | γ₅₇ |
| 6 | γ₆₀ | γ₆₁ | γ₆₂ | γ₆₃ | γ₆₄ | γ₆₅ | γ₆₆ | γ₆₇ |
| 7 | γ₇₀ | γ₇₁ | γ₇₂ | γ₇₃ | γ₇₄ | γ₇₅ | γ₇₆ | γ₇₇ |

In a case where the terminal device senses the PSCCH transmitted by another terminal device, the terminal device acquires the priority P1 carried in the first sidelink control information transmitted in the PSCCH and the priority P2 of the to-be-transmitted data, and determines an SL-RSRP threshold by looking up in Table 1.

(2). Whether the terminal device compares the measured PSCCH-RSRP or a PSSCH-RSRP scheduled by the PSCCH with the SL-RSRP threshold depends on the resource pool configuration of the resource pool used by the terminal device. The resource pool configuration may be configured on the network or preconfigured.

(3). The value of X as described above is possibly {20%, 35%, 50%}. The configuration of the resource pool used by the terminal device includes correspondence between the priorities and the possible values described above, and the terminal device determines the value of X based on the priority of the to-be-transmitted data and the correspondence. The resource pool may be configured on the network or preconfigured.

(4) The resource reservation period is converted into logical slots:

As mentioned above, the terminal device transmits the first sidelink control information to indicate time-frequency resources to reserve resources to be used next. In sensing, the terminal device for resource selection decodes the first sidelink control information transmitted by other terminal devices to acquire resources reserved by the other terminal devices, and then excludes the corresponding resources during resource selection, such that resource collision is avoided. In resource exclusion, the terminal device for resource selection converts a physical time (for example, 100 ms) indicated by the “resource reservation period” field in the decoded first sidelink control information into a corresponding number of logical slots, and then performs resource exclusion using the number of the logical slots:

$${P}_{rsvp}^{′} = ⌈ \frac{{T}_{max}^{′}}{10240 ms} \times {P}_{rsvp} ⌉$$

In the above formula, Prsvp is a resource reservation period, for example, a resource reservation period indicated by the “resource reservation period” in the first sidelink control information sensed by the terminal device, or a resource reservation period allowed in the resource pool, or a resource reservation period of the terminal device, and P′rsvp is a calculated number of corresponding logical slots. T′max is a number of slots within a resource pool or a transmission resource pool of the terminal device in a system frame number (SFN) period or in 10240 ms.

The above description is for the SL communication method in NR-V2X. That is, the terminal device independently selects transmission resources by resource sensing and independently performs data transmission on the SL. The SL communication method is applicable to various SL communications such as direct communication between handheld terminals and direct communication between pedestrians and vehicles.

### 5. Multi-Beam System

A design objective of the NR/5G system includes large-bandwidth communication in high frequency bands (e.g., frequency bands above 6 GHZ). As the operating frequency increases, the path loss during transmission increases, such that the coverage capability of the high-frequency system is affected. For the coverage of the high-frequency band NR system, an effective technical solution is to form higher-gain shaped beams based on massive multiple-input multiple-output (MIMO) antenna arrays, such that the propagation loss is reduced, and the system coverage is ensured.

Millimeter-wave antenna arrays, due to their shorter wavelengths and smaller antenna element spacing and aperture, allow more physical antenna elements to be integrated into a two-dimensional antenna array of a limited size. In addition, given the limited size of the millimeter-wave antenna arrays, digital beamforming is impractical in consideration of factors such as hardware complexity, cost overheads, and power consumption. Instead, analog beamforming is typically used to enhance the network coverage and reduce the complexity for device implementation.

In conventional 2G/3G/4G systems, for a single cell (sector), a wide beam is typically used to cover the entire cell. Thus, at any given moment, a UE within the coverage region of the cell has an opportunity to acquire a transmission resource allocated by the system.

In the NR/5G multi-beam system, however, the entire cell is covered by a plurality of different beams. That is, each of the beams covers a small region, and the entire cell is covered by the plurality of beams through sweeping over time.

FIG. 5 is a schematic diagram illustrating a system without beamforming and a system with beamforming. The left sub-figure (a) represents conventional LTE and NR systems without beamforming, and the right sub-figure (b) represents an NR system with beamforming.

In the left sub-figure (a), the LTE/NR network uses a single wide beam to cover the entire cell, allowing the terminal devices 1 to 5 to receive network signals at any moment.

In contrast, in the right sub-figure (b), the network uses narrower beams (e.g., beams 1 to 4 in the figure), such that different regions in the cell are covered by different beams at different moments. For example, at moment 1, the NR network covers the region where the terminal device 1 is located using beam 1; at moment 2, the NR network covers the region where the terminal device 2 is located using beam 2; at moment 3, the NR network covers the regions where the terminal device 3 and the terminal device 4 are located using beam 3; and at moment 4, the NR network covers the region where the terminal device 5 is located using beam 4.

In the right sub-figure (b), the use of the narrower beams by the network allows transmission energy to be more concentrated, such that the coverage range is wider. In addition, since the beams are narrower, each beam cover only partial region in the cell, such that the analog beamforming is a “time-for-space” trade-off.

The analog beamforming is applicable not only to network devices but also to terminal devices. In addition, the analog beamforming is applicable not only to signal transmission (referred to as transmit beams), but also to signal reception (referred to as receiver beams).

### 6. Method for Resource Selection Based on Inter-Terminal Coordination

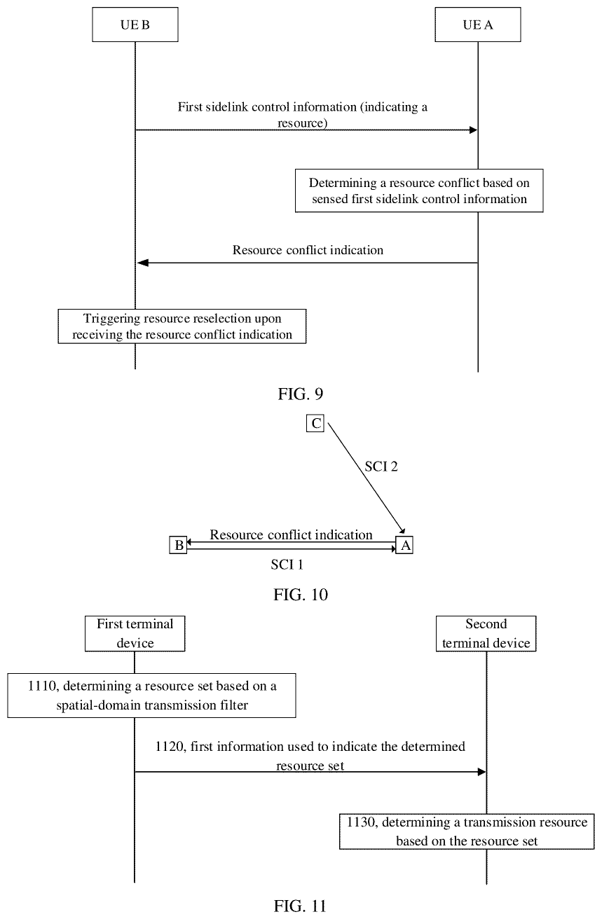

In standardization research, the SL communication method in which the terminal device independently selects resources through sensing has been further optimized, and an SL communication method in which terminal devices coordinate with each other to select resources has been provided, which mainly includes two schemes: Scheme 1 and Scheme 2. In Scheme 1, UE A generates a preferred resource set or a non-preferred resource set based on sensing, and the preferred resource set or the non-preferred resource set refers to a set of resources suitable for transmission of UE B or unsuitable for transmission of UE B. UE A transmits the preferred resource set or the non-preferred resource set to UE B, and UE B determines a transmission resource based on the resource set. In Scheme 2, UE B transmits an SCI to indicate a reserved transmission resource. In the case where UE A determines a resource conflict between the reserved resource indicated by UE B and a reserved resource indicated by another terminal, UE A may transmit a 1-bit resource conflict indication to UE B. UE B triggers resource reselection upon receiving the resource conflict indication. Scheme 1 and Scheme 2 are described in detail hereinafter with reference to FIGS. 6 and 9.

For example, FIG. 6 is a schematic flowchart of Scheme 1. UE B is a terminal that independently selects a resource, and UE A is a terminal that determines a preferred resource set or a non-preferred resource set. In selecting the resource, UE B may also take into account the resource set from UE A to further avoid resource collisions between the selected resource and resources from other UEs, such that the communication reliability is improved.

Two main trigger mechanisms are provided for such inter-UE coordination:

(1) UE B initiates the coordination and transmits trigger or request information to UE A, and UE A receives the trigger or request information and determines and transmits a resource set to UE B.

(2) UE A initiates the coordination, and UE A transmits a resource set to UE B in the case where a condition is met. For example, UE A transmits a resource set to UE B in the case where UE A satisfies a periodic condition.

For the preferred resource set, UE A is generally a receiver of data from UE B, and UE A initializes a candidate resource set from the perspective of the receiver. In some embodiments, UE A performs resource exclusion based on unmonitored slots and/or sensed sidelink control information. In some embodiments, UE A further excludes resources where reception is not expected due to half-duplex constraints. The post-exclusion candidate resource set is determined as the preferred resource set and transmitted to UE B. UE B may take an intersection between a candidate resource set generated by UE B itself and the preferred resource set, and select a transmission resource from the intersection.

For the non-preferred resource set, UE A may or may not be a receiver of data from UE B. For example, UE A is a receiver of another UE C.

In a case where UE A is the receiver of UE B, and an SL-RSRP of a PSCCH corresponding to first sidelink control information sensed by UE A or an SL-RSRP of a PSSCH scheduled by the PSCCH is greater than a threshold value, resources indicated by the first sidelink control information is determined as resources in the non-preferred resource set. Exemplarily, the indicated resources are resources indicated by a time resource assignment field and a frequency resource assignment field. UE A may further include resources where reception is not expected due to half-duplex constraints in the non-preferred resource set.

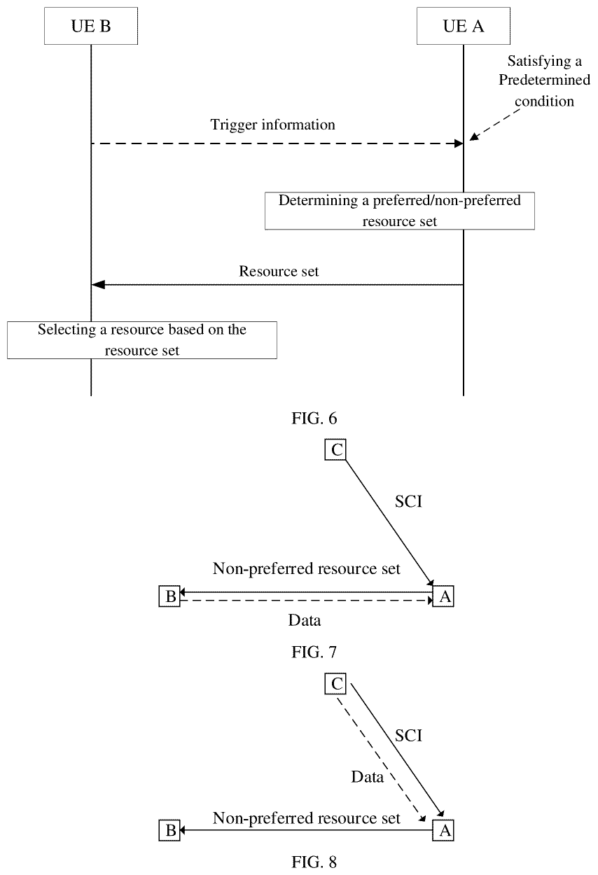

As illustrated in FIG. 7, UE A is the receiver of data from UE B. In the case where UE A, as a receiver, receives an SCI with a high RSRP from UE C, UE A includes resources indicated by the SCI as resources in the non-preferred resource set, and then informs UE B to exclude these non-preferred resources by UE B, such that UE B and UE C do not select the same resource. This is because if UE B selects the same resource as UE C, UE A, as the receiver, may experience strong interference from UE C in receiving data from UE B. UE C is any terminal other than UE A and UE B. That is, the non-preferred resource set may include resources indicated by a plurality of pieces of SCI from a plurality of UEs C.

In a case where UE A is not the receiver of data from UE B, an SL-RSRP of a PSCCH corresponding to first sidelink control information received by UE A or an SL-RSRP of a PSSCH scheduled by the PSCCH is less than a threshold value, and UE A is a receiver of the PSSCH scheduled by the PSCCH, resources indicated by the first sidelink control information are determined as resources in the non-preferred resource set, and the non-preferred resource set is indicated to UE B.

For example, as illustrated in FIG. 8, UE A is not the receiver of data from UE B, but a receiver of data from UE C. In the case where UE A receives SCI from UE C, and detects that an SL-RSRP of the SCI is low, which indicates susceptibility to interference, UE A includes resources indicated by the SCI from UE C as resources in the non-preferred resource set. That is, UE B is informed to avoid selecting the same time-frequency resources as UE C, and the reception from UE C to UE A is not interfered as the link from UE C to UE A is vulnerable. UE C is any terminal other than UE A and UE B. That is, the non-preferred resource set may include resources indicated by a plurality of pieces of SCI from a plurality of UEs C.

Upon receiving the non-preferred resource set, UE B excludes candidate resources overlapped with the resources in the non-preferred resource set from the candidate resource set generated by UE B itself.

For example, FIG. 9 is a schematic flowchart of Scheme 2. UE B transmits first sidelink control information 1 to indicate a transmission resource, and UE C transmits first sidelink control information 2 to indicate the transmission resource. UE A receives both first sidelink control information 1 from UE B and first sidelink control information 2 from UE C.

In the case where UE A is the receiver of data from UE B, UE A transmits a resource conflict indication to UE B in the case where condition 1 is satisfied. UE A also transmits a resource conflict indication to UE B in the case where conditions 2, 4, and 5 are satisfied or conditions 3, 4, and 5 are satisfied.

Condition 1: UE A does not expect resource reception in a slot where the reserved resource indicated by UE B in the first sidelink control information 1 is located, due to half-duplex constraints.

Condition 2: An SL-RSRP of a PSCCH carrying first sidelink control information 2 or a PSSCH scheduled by the PSCCH is higher than a threshold value.

Condition 3: The SL-RSRP of the PSCCH carrying first sidelink control information 2 or the PSSCH scheduled by the PSCCH is higher than a sum of an SL-RSRP of a PSCCH carrying first sidelink control information 1 or an SL-RSRP of a PSSCH scheduled by the PSCCH and a configured threshold.

Condition 4: The reserved resource indicated by first sidelink control information 2 is overlapped with the reserved resource indicated by first sidelink control information 1.

Condition 5: A priority indicated by first sidelink control information 2 is higher than a priority indicated by first sidelink control information 1.

In the case where UE A is the receiver of data from UE C, UE A transmits a resource conflict indication to UE B in the case where conditions 1, 3, and 4 are all satisfied or conditions 2, 3, and 4 are all satisfied.

Condition 1: An SL-RSRP of a PSCCH carrying first sidelink control information 1 or a PSSCH scheduled by the PSCCH is higher than a threshold value.

Condition 2: The SL-RSRP of the PSCCH carrying first sidelink control information 1 or the PSSCH scheduled by the PSCCH is higher than a sum of an SL-RSRP of a PSCCH carrying first sidelink control information 2 or an SL-RSRP of a PSSCH scheduled by the PSCCH and a configured threshold.

Condition 3: The reserved resource indicated by first sidelink control information 2 is overlapped with the reserved resource indicated by first sidelink control information 1.

Condition 4: A priority indicated by first sidelink control information 2 is higher than a priority indicated by first sidelink control information 1.

Exemplarily, the reserved resources indicated by the first sidelink control information refer to resources indicated by the time resource assignment field and the frequency resource assignment field, excluding a resource currently for transmitting the first sidelink control information. For example, the two fields indicate three resources, including resources 1, 2, and 3. Resource 1 is the resource for transmitting the first sidelink control information, and then the reserved resources indicated by the first sidelink control information are resources 2 and/or 3. Exemplarily, upon receiving the resource conflict indication, UE B reselects the reserved resource indicated by first sidelink control information 1.

For example, as illustrated in FIG. 10, UE B transmits SCI 1, and UE C transmits SCI 2. UE A detects the two pieces of SCI, and determines that the reserved resources indicated by these two pieces of SCI are overlapped with each other. In the case where UE A is the receiver of UE B, a higher RSRP of SCI 2 may interfere the transmission from UE B to UE A. In the case where the priority of SCI 1 is lower, the resource conflict indication is transmitted to UE B, and then UE B triggers resource reselection to avoid a resource conflict. In the case where UE A is the receiver of UE C, a higher RSRP of SCI 1 may interfere the transmission from UE C to UE A. In the case where the priority of SCI 1 is lower, the resource conflict indication is transmitted to UE B, and then UE B triggers resource reselection to avoid a resource conflict.

Current standardization discussions are addressing issues related to SL systems operating at high frequencies. For an SL system operating at a high frequency, beams are inevitably introduced. For example, a transmit beam is used for transmission, or a receiver beam is used for reception. It is known from above description that in the existing SL resource selection mechanism based on inter-terminal coordination, UE A determines a resource set or a resource conflict based on sensing, and indicates the resource set or the resource conflict to UE B. UE B then avoids resource conflicts with other terminals based on the resource set or a resource conflict indication. With the introduction of beams, UE A also performs sensing based on beams. However, how to determine a resource set or a resource conflict criterion based on beams has not yet been discussed. For example, in Scheme 1, it is to be discussed whether UE A determines a beam for sensing based on trigger information transmitted from UE B to UE A and further determines a preferred resource set or a non-preferred resource set based on an SCI sensing result in the direction of the beam. For example, in Scheme 2, it is to be discussed whether beams need to be considered in conditions for determining a resource conflict. For example, in the case where UE B and UE C use overlapping time-frequency resources but perform transmission in different beam directions, causing no interference, UE A determines that no resource conflict occurs. In addition, a plurality of transmit beams may be configured for UE B, and then it is to be discussed how UE B determines which beam the assistance information transmitted by UE A is applicable to, or the like. In the present disclosure, beam-based inter-terminal coordination methods are provided respectively for the preferred resource set or the non-preferred resource set in Scheme 1 and for Scheme 2.

According to the technical solutions provided in the present disclosure, by combining the transmission and reception of beams with the resource selection mechanism based on inter-terminal coordination, the existing resource selection mechanism based on inter-terminal coordination is applicable to high-frequency communications, such that resource conflicts between terminals operating at high frequencies are effectively avoided, and the communication reliability is improved.

It should be noted that, in the present disclosure, the “beam” is also referred to as a “spatial-domain transmission filter”, which have the same meaning. Accordingly, the “receiver beam” is also referred to as a “spatial-domain reception filter”, a “receiver spatial-domain filter”, a “spatial-domain transmission filter for reception”, a “spatial-domain transmission filter used in reception”, or another name, and the “transmit beam” is also referred to as a “spatial-domain transmitter filter”, a “transmitting end spatial-domain filter”, a “spatial-domain transmission filter for transmission”, a “spatial-domain transmission filter used in transmission”, or another name, which are not limited in the present disclosure.

In addition, in the present disclosure, the “time unit” may be a slot, a subframe, or another time unit, which is not limited in the present disclosure. For the “time unit” mentioned elsewhere herein, this explanation applies and will not be repeated.

FIG. 11 is a flowchart of a method for resource selection based on inter-terminal coordination according to some embodiments of the present disclosure. The method includes at least one of the following S1110 to S1130.

In S1110, a first terminal device determines a resource set based on a spatial-domain transmission filter.

In some embodiments, the resource set is a preferred resource set. For example, the resource set is a preferred resource set indicated to a second terminal device, and the resource set includes resources suitable for use by the second terminal device.

In some embodiments, the resource set is a non-preferred resource set. For example, the resource set is a non-preferred resource set indicated to the second terminal device, and the resource set includes resources unsuitable for use by the second terminal device.

In the embodiments of the present disclosure, the first terminal device may be any terminal device, and the second terminal device is another terminal device different from the first terminal device. In some embodiments, the first terminal device is a terminal device that determines a resource set, and the second terminal device is a terminal device that determines a transmission resource.

In some embodiments, the spatial-domain transmission filter is a spatial-domain transmission filter used by the first terminal device for reception. The spatial-domain transmission filter used by the first terminal device for reception is also referred to as a receiver beam of the first terminal device, and the first terminal device determines the resource set indicated to the second terminal device based on the receiver beam thereof.

In some embodiments, the spatial-domain transmission filter is determined based on second information transmitted by the second terminal device, and the second information is used to trigger or request the first terminal device to determine the resource set. In some embodiments, the first terminal device receives the second information from the second terminal device, determines a spatial-domain transmission filter based on the second information, and determines the resource set indicated to the second terminal device based on the determined spatial-domain transmission filter.

In some embodiments, the spatial-domain transmission filter is a spatial-domain transmission filter used by the first terminal device to receive the second information.

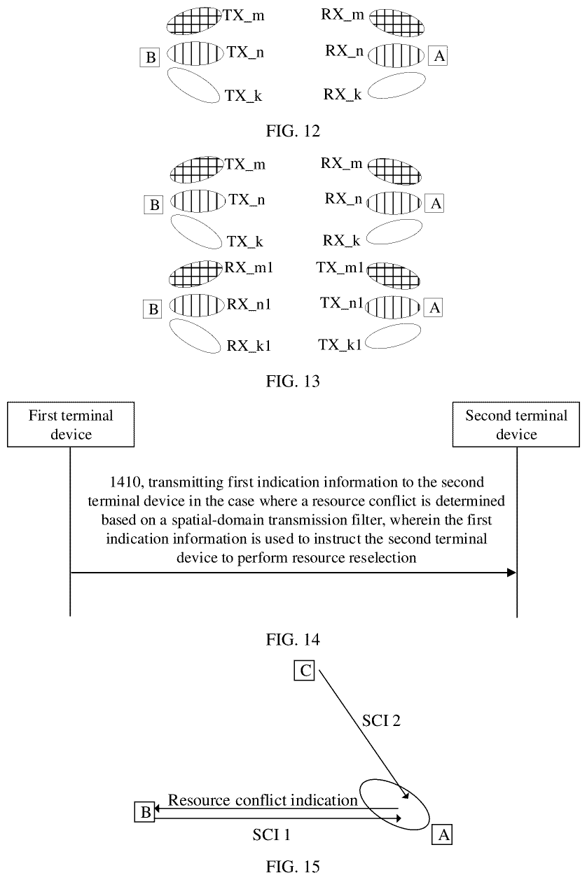

For example, as illustrated in FIG. 12, UE A (corresponding to the first terminal device) is provided with three receiver beams: RX_m, RX_n, and RX_k. UE B (corresponding to the second terminal device) transmits the second information to UE A. The second information is used to trigger or request UE A to determine the resource set. UE A receives the second information using a beam. Assuming that the beam used by UE A for receiving the second information is RX_n, UE A determines the resource set indicated to UE B based on RX_n.

In some embodiments, the second information includes a first indicator field, and the first terminal device determines the spatial-domain transmission filter based on the first indicator field in the second information. The first indicator field is used to indicate at least one spatial-domain transmission filter used by the second terminal device for transmission. For example, the first indicator field is used to indicate a transmission configuration indication (TCI) state, or a channel state information-reference signal (CSI-RS), or a resource carrying the CSI-RS, or quasi co-location (QCL) information corresponding to the spatial-domain transmission filter used by the second terminal device for transmission. The first indicator field is used to indicate one or more spatial-domain transmission filters. The first terminal device determines, based on the first indicator field, the spatial-domain transmission filter that is used by the first terminal device for reception and corresponds to the spatial-domain transmission filter used by the second terminal device for transmission.

For example, as illustrated in FIG. 12, UE A (corresponding to the first terminal device) is provided with three receiver beams: RX_m, RX_n, and RX_k. UE B (corresponding to the second terminal device) is provided with three transmit beams: TX_m, TX_n, and TX_k. Moreover, the three transmit beams of UE B are in a one-to-one correspondence to the three receiver beams of UE A, that is, TX_m corresponds to RX_m, TX_n corresponds to RX_n, and TX_k corresponds to RX_k. UE B transmits the second information using TX_n, and the second information is used to trigger or request UE A to determine the resource set, and includes the first indicator field. The first indicator field indicates a CSI-RS corresponding to TX_m, and UE A determines the resource set indicated to UE B based on RX_m. For example, the first indicator field indicates CSI-RSs corresponding to TX_m and TX_k, UE A determines the resource set indicated to UE B based on RX_m and RX_k.

In some embodiments, the spatial-domain transmission filter is determined by the first terminal device autonomously. Exemplarily, the first terminal device determines one or more spatial-domain transmission filters from one or more spatial-domain transmission filters for receiving data from the second terminal device.

For example, as illustrated in FIG. 12, UE A (corresponding to the first terminal device) is provided with three receiver beams: RX_m, RX_n, and RX_k. Based on the implementation of UE A, UE A autonomously determines RX_m used to determine the resource set indicated to UE B, or autonomously determines RX_m and RX_k used to determine the resource set indicated to UE B, as selected from the three receiver beams RX_m, Rx_n, and Rx_k for receiving data from UE B (corresponding to the second terminal device).

In some embodiments, upon determining the one or more spatial-domain transmission filters, the first terminal device determines a resource set corresponding to each of the spatial-domain transmission filters. For example, as illustrated in FIG. 12, upon determining RX_m and RX_k based on the first indicator field in the second information, or upon determining RX_m and RX_k autonomously, UE A determines a resource set corresponding to RX_m based on RX_m, and determines a resource set corresponding to RX_k based on RX_k. Subsequently, UE A indicates the resource set corresponding to RX_m and the resource set corresponding to RX_k to UE B.

In some embodiments, in the case where the resource set includes resources suitable for use by the second terminal device, the first terminal device determines the preferred resource set using the following method. The first terminal device initializes the resource set, wherein the resource set includes available resources within a resource selection window, and acquire a post-exclusion resource set by performing resource exclusion on the resource set based on sensed first sidelink control information, wherein the sensed first sidelink control information includes at least one of: first sidelink control information received by the determined spatial-domain transmission filter, or first sidelink control information received omnidirectionally. The first terminal device determines the post-exclusion resource set as the preferred resource set. In some embodiments, the resource selection window is indicated to the first terminal device by the second terminal device (e.g., via the second information), or depends on the implementation of the first terminal device. In some embodiments, the first terminal device further excludes resources from the resource set which is not expected for exception due to half-duplex constraints. In some embodiments, the first terminal device further performs resource exclusion on the resource set based on unmonitored time units.

In some embodiments, performing resource exclusion based on the first sidelink control information received by the determined spatial-domain transmission filter includes: determining a signal quality threshold table corresponding to the determined spatial-domain transmission filter based on a correspondence between spatial-domain transmission filters and signal quality threshold tables; determining a signal quality threshold in the signal quality threshold table corresponding to the spatial-domain transmission filter based on a first priority and a priority indicated by the first sidelink control information received by the spatial-domain transmission filter; and performing the resource exclusion on the resource set based on the first sidelink control information received by the spatial-domain transmission filter in the case where a signal quality corresponding to the first sidelink control information received by the spatial-domain transmission filter is greater than the signal quality threshold. In some embodiments, the correspondence between spatial-domain transmission filters and signal quality threshold tables includes a correspondence between at least one spatial-domain transmission filter and at least one signal quality threshold table. Exemplarily, each spatial-domain transmission filter has a corresponding signal quality threshold table. Exemplarily, different spatial-domain transmission filters correspond to different signal quality threshold tables. Exemplarily, at least two spatial-domain transmission filters correspond to the same signal quality threshold table. In some embodiments, the correspondence is configured by a network, pre-configured, or predefined in a protocol. In some embodiments, the signal quality refers to an RSRP or an SL-RSRP. In some embodiments, the first priority is indicated to the first terminal device by the second terminal device (e.g., via the second information), or depends on the implementation of the first terminal device. In addition, for the process of performing the resource exclusion on the resource set based on the received first sidelink control information, reference may be made to above description, which will not be repeated herein.

In some embodiments, in the case where the resource set includes resources unsuitable for use by the second terminal device, the method for the first terminal device to determine the non-preferred resource set is discussed in the following two cases.

In case 1, in the case where a signal quality corresponding to sensed first sidelink control information is greater than a signal quality threshold, the resource set includes resources indicated by the sensed first sidelink control information, wherein the sensed first sidelink control information includes at least one of: first sidelink control information received by the determined spatial-domain transmission filter, or first sidelink control information received omnidirectionally.

In some embodiments, the signal quality corresponding to the first sidelink control information refers to a signal quality of a PSCCH corresponding to the first sidelink control information, or a signal quality of a PSSCH scheduled by the PSCCH. The PSCCH corresponding to the first sidelink control information may be understood as a PSCCH carrying the first sidelink control information. In some embodiments, the signal quality refers to an RSRP or an SL-RSRP. In some embodiments, in the case where the SL-RSRP of the PSCCH corresponding to the first sidelink control information received by the first terminal device using the determined spatial-domain transmission filter and/or the first sidelink control information received omnidirectionally or the SL-RSRP of the PSSCH scheduled by the PSCCH is greater than an RSRP threshold, resources indicated by the first sidelink control information are determined as resources in the non-preferred resource set. Exemplarily, the indicated resources are resources indicated by the time resource assignment field and the frequency resource assignment field. In some embodiments, the first terminal device further includes resources where reception is not expected due to half-duplex constraints in the non-preferred resource set.

Case 1 is applicable to scenarios where the first terminal device is a receiver of data transmitted by the second terminal device. The first terminal device determines resources indicated by sensed first sidelink control information with a high signal quality transmitted by other terminal devices as non-preferred resources, thereby avoiding strong interference from other terminal devices when the first terminal device receives the data from the second terminal device.

In case 2, in the case where a signal quality corresponding to sensed first sidelink control information is less than a signal quality threshold, and the first terminal device is a receiver of a PSSCH scheduled by a PSCCH corresponding to the sensed first sidelink control information, the resource set includes resources indicated by the sensed first sidelink control information, wherein the sensed first sidelink control information includes at least one of: first sidelink control information received by the determined spatial-domain transmission filter, or first sidelink control information received omnidirectionally.

In some embodiments, the signal quality corresponding to the first sidelink control information refers to a signal quality of a PSCCH corresponding to the first sidelink control information, or a signal quality of a PSSCH scheduled by the PSCCH. The PSCCH corresponding to the first sidelink control information may be understood as a PSCCH carrying the first sidelink control information. In some embodiments, the signal quality refers to an RSRP or an SL-RSRP. In some embodiments, in the case where the SL-RSRP of the PSCCH corresponding to the first sidelink control information received by the first terminal device using the determined spatial-domain transmission filter and/or the first sidelink control information received omnidirectionally or the SL-RSRP of the PSSCH scheduled by the PSCCH is less than an RSRP threshold, and the first terminal device is the receiver of the PSSCH scheduled by the PSCCH, resources indicated by the first sidelink control information are determined as resources in the non-preferred resource set. Exemplarily, the indicated resources are resources indicated by the time resource assignment field and the frequency resource assignment field.

Case 2 is applicable to scenarios where the first terminal device is not a receiver of data transmitted by the second terminal device. For example, the first terminal device is a receiver of data transmitted by a third terminal device, and the third terminal device is another terminal device different from the first terminal device and the second terminal device. The first terminal device determines resources indicated by sensed first sidelink control information with a low signal quality transmitted by the third terminal device as non-preferred resources, thereby avoiding strong interference from other terminal devices (such as the second terminal device) when the first terminal device receives the data from the third terminal device.

In some embodiments, in the case where the first sidelink control information is received using the determined spatial-domain transmission filter, the signal quality threshold is determined by: determining a signal quality threshold table corresponding to the determined spatial-domain transmission filter based on a correspondence between spatial-domain transmission filters and signal quality threshold tables; and determining the signal quality threshold in the signal quality threshold table corresponding to the spatial-domain transmission filter based on a priority indicated by the first sidelink control information received by the spatial-domain transmission filter. In some embodiments, the correspondence between spatial-domain transmission filters and signal quality threshold tables includes a correspondence between at least one spatial-domain transmission filter and at least one signal quality threshold table. Exemplarily, each spatial-domain transmission filter has a corresponding signal quality threshold table. Exemplarily, different spatial-domain transmission filters correspond to different signal quality threshold tables. Exemplarily, at least two spatial-domain transmission filters correspond to the same signal quality threshold table. In some embodiments, the correspondence is configured by a network, pre-configured, or predefined in a protocol. In some embodiments, the above signal quality refers to an RSRP or an SL-RSRP.

In S1120, the first terminal device transmits first information to the second terminal device, wherein the first information is used to indicate the determined resource set.

Accordingly, the second terminal device receives the first information from the first terminal device, wherein the first information is used to indicate the resource set determined by the first terminal device based on the spatial-domain transmission filter.

In some embodiments, the first information is used to indicate at least one resource set. For example, the first information is used to indicate one or more resource sets.

In some embodiments, the first information is further used to indicate a spatial-domain transmission filter used by the second terminal device for transmission. In some embodiments, the first information includes a second indicator field, wherein the second indicator field is used to indicate the spatial-domain transmission filter used by the second terminal device for transmission. For example, the second indicator field is used to indicate a TCI state, or a CSI-RS, or a resource carrying the CSI-RS, or QCL information corresponding to the spatial-domain transmission filter used by the second terminal device for transmission.

In some embodiments, the first information (that is, the second indicator field) is used to indicate at least one spatial-domain transmission filter used by the second terminal device for transmission. For example, the first information (or the second indicator field) is used to indicate one or more spatial-domain transmission filters used by the second terminal device for transmission. In some embodiments, a correspondence exists between the at least one spatial-domain transmission filter indicated by the first information and the at least one resource set indicated by the first information. In some embodiments, a correspondence exists between the at least one spatial-domain transmission filter indicated by the first information and the spatial-domain transmission filter based on which the first terminal device determines the above at least one resource set.

As illustrated in FIG. 12, UE A (corresponding to the first terminal device) is provided with three receiver beams: RX_m, RX_n, and RX_k. UE B (corresponding to the second terminal device) is provided with three transmit beams: TX_m, TX_n, and TX_k. Moreover, the three transmit beams of UE B are in a one-to-one correspondence to the three receiver beams of UE A, that is, TX_m corresponds to RX_m, TX_n corresponds to RX_n, and TX_k corresponds to RX_k. Assuming that UE A determines resource set n using RX_n, UE A transmits first information to indicate resource set n and TX_n. For example, the first information indicates a CSI-RS corresponding to TX_n. For example, UE A determines resource sets n and k using RX_n and Rx_k, UE A transmits first information to indicate resource sets n and k and TX_n and TX_k. For example, the first information indicates CSI-RSs associated with TX_n and TX_k.

In S1130, the second terminal device determines a transmission resource based on the resource set.

In some embodiments, upon receiving the first information from the first terminal device, the second terminal device determines, based on the first information, at least one resource set and a spatial-domain transmission filter used by the second terminal device for transmission corresponding to the at least one resource set.

In some embodiments, the resource set includes resources suitable for use by the second terminal device (i.e., the resource set is a preferred resource set), or the resource set includes resources unsuitable for use by the second terminal device (i.e., the resource set is a non-preferred resource set).

In some embodiments, a resource for the second terminal device to transmit data using a first spatial-domain transmission filter is determined based on a resource set corresponding to the first spatial-domain transmission filter in the resource set indicated by the first information. The first spatial-domain transmission filter is any spatial-domain transmission filter used by the second terminal device for transmission. For example, the first spatial-domain transmission filter is a spatial-domain transmission filter for data transmission as determined by the second terminal device.

In some embodiments, the second terminal device determines the spatial-domain transmission filter used by the second terminal device for transmission based on a spatial-domain transmission filter for receiving the first information. Exemplarily, a correspondence exists between the spatial-domain transmission filter used by the second terminal device for reception and the spatial-domain transmission filter used by the second terminal device for transmission. The spatial-domain transmission filter used by the second terminal device for transmission and determined by the second terminal device corresponds to the resource set indicated by the first information.

As illustrated in FIG. 13, three transmit beams TX_m, TX_n, and TX_k of UE B (corresponding to the second terminal device) respectively correspond to three receiver beams RX_m, RX_n, and RX_k of UE A. Exemplarily, in the case where UE B uses TX_m for data transmission, UE A uses RX_m for data reception. Meanwhile, three transmit beams TX_ml, TX_nl, and TX_kl of UE A respectively correspond to three receiver beams RX_ml, RX_nl, and RX kl of UE B. That is, in the case where UE A uses TX_ml for data transmission, UE B uses RX_ml for data reception.

UE B transmits second information using TX_n, wherein the second information is used to trigger or request UE A to determine a resource set. UE A receives the second information using RX_n, and then UE A determines a preferred resource set or a non-preferred resource set based on RX_n. With a beam correspondence between RX_n and TX_nl of UE A, UE A transmits first information using the beam TX_nl, wherein the first information indicates a determined resource set. UE B receives the first information using RX_nl. With a beam correspondence between RX_nl and TX_n of UE B, a transmission resource for UE B to transmit data using TX_n is determined based on the resource set.

In some embodiments, the second terminal device determines, based on an indication of the first information, one or more resource sets and one or more spatial-domain transmission filters used by the second terminal device for transmission corresponding to the one or more resource sets. For example, the one or more spatial-domain transmission filters used by the second terminal device for transmission are determined based on the second indicator field.

As illustrated in FIG. 13, three transmit beams TX_m, TX_n, and TX_k of UE B (corresponding to the second terminal device) respectively correspond to three receiver beams RX_m, RX_n, and RX_k of UE A. Exemplarily, in the case where UE B uses TX_m for data transmission, UE A uses RX_m for data reception. Meanwhile, three transmit beams TX_ml, TX_nl, and TX_kl of UE A respectively correspond to three receiver beams RX_ml, RX_nl, and RX kl of UE B. That is, in the case where UE A uses TX_ml for data transmission, UE B uses RX_ml for data reception.

UE B transmits second information using TX_n, wherein the second information is used to trigger or request UE A to determine a resource set. UE A receives the second information using RX_n. In the case where the second information indicates TX_m, UE A determines a preferred resource set or a non-preferred resource set based on RX_m. UE A transmits first information using a beam TX_nl, and UE B receives the first information using RX_nl. The first information indicates a determined resource set, and the first information indicates TX_m corresponding to the resource set. A transmission resource for UE B to transmit data using TX_m is determined based on the resource set.

In some embodiments, the second terminal device initializes one or more candidate resource sets. For example, in the case where a spatial-domain transmission filter used by the second terminal device for transmission has been determined, a candidate resource set is initialized, and the candidate resource set corresponds to the spatial-domain transmission filter used for information transmission. For example, in the case where a spatial-domain transmission filter used by the second terminal device for transmission has not been determined, the second terminal device initializes a plurality of candidate resource sets for a plurality of spatial-domain transmission filters used for transmission. For example, the second terminal device initializes a candidate resource set corresponding to each of the plurality of spatial-domain transmission filters used for transmission.

For any candidate resource set of the second terminal device, the second terminal device performs resource exclusion based on unmonitored time units and/or sensed first sidelink control information. In some embodiments, in the case where a spatial-domain transmission filter used by the second terminal device for transmission corresponding to the candidate resource set matches a spatial-domain transmission filter used by the second terminal device for transmission corresponding to a resource set received by the second terminal device, and the resource set is a preferred resource set, the second terminal device takes an intersection between the post-resource-exclusion candidate resource set and the preferred resource set, and selects a transmission resource from the intersection. In some embodiments, in the case where a spatial-domain transmission filter used by the second terminal device for transmission corresponding to the candidate resource set matches a spatial-domain transmission filter used by the second terminal device for transmission corresponding to a resource set received by the second terminal device, and the resource set is a non-preferred resource set, the second terminal device excludes resources overlapping with resources in the non-preferred resource set from the candidate resource set, and selects a transmission resource from the post-resource-exclusion candidate resource set. In some embodiments, in the case where a spatial-domain transmission filter used by the second terminal device for transmission corresponding to the candidate resource set does not match any of spatial-domain transmission filters used by the second terminal device for transmission corresponding to resource sets received by the second terminal device, the second terminal device selects a transmission resource from the post-resource-exclusion candidate resource set.

Exemplarily, when initializing a plurality of candidate resource sets, the second terminal device determines a transmission resource corresponding to each candidate resource set. Upon determining a spatial-domain transmission filter used for transmission, the second terminal device determines a resource determined from a candidate resource set corresponding to the spatial-domain transmission filter as a transmission resource.

According to the technical solutions in the embodiments of the present disclosure, for an SL communication system, a first terminal device determines a resource set based on a spatial-domain transmission filter and indicates the determined resource set to a second terminal device, and the second terminal device determines a transmission resource based on the resource set. In this way, the transmission and reception of beams is combined with the resource selection mechanism based on inter-terminal coordination, such that the existing resource selection mechanism based on inter-terminal coordination is applicable to high-frequency communications, such that resource conflicts between terminals operating at high frequencies are effectively avoided, and the communication reliability is improved.

FIG. 14 is a flowchart of a method for resource selection based on inter-terminal coordination according to some embodiments of the present disclosure. The method includes the following S1410.

In S1410, in the case where a resource conflict is determined based on a spatial-domain transmission filter, the first terminal device transmits first indication information to the second terminal device, wherein the first indication information is used to instruct the second terminal device to perform resource reselection.

Accordingly, the second terminal device receives the first indication information from the first terminal device in the case where the resource conflict is determined based on the spatial-domain transmission filter, wherein the first indication information is used to instruct the second terminal device to perform resource reselection.

In some embodiments, the first indication information is also referred to as a resource conflict indication. In some embodiments, the first indication information is carried via a PSFCH.

The first terminal device receives first sidelink information and second sidelink information. The first sidelink information is sidelink control information transmitted by the second terminal device to indicate a transmission resource, and the second sidelink information is sidelink control information transmitted by a third terminal device to indicate the transmission resource. The first terminal device, the second terminal device, and the third terminal device are three different terminal devices.

In case 1, the first terminal device is a receiver of data transmitted by the second terminal device. The first terminal device determines a resource conflict and transmits the first indication information to the second terminal device in the case where a first condition or a second condition is satisfied, and a third condition, a fourth condition, and a fifth condition are satisfied.

The first condition is that a signal quality corresponding to the second sidelink information is greater than a first threshold.

The second condition is that the signal quality corresponding to the second sidelink information is greater than a signal quality corresponding to the first sidelink information, or a sum of the signal quality corresponding to the first sidelink information and a second threshold.

The third condition is that the transmission resource indicated by the second sidelink information is overlapped with the transmission resource indicated by the first sidelink information.

The fourth condition is that a priority indicated by the second sidelink information is higher than a priority indicated by the first sidelink information.

The fifth condition is that a spatial-domain transmission filter used by the first terminal device to receive the first sidelink information and a spatial-domain transmission filter used by the first terminal device to receive the second sidelink information both satisfy a predetermined condition.

In case 2, the first terminal device is a receiver of data transmitted by the third terminal device. The first terminal device determines a resource conflict and transmits the first indication information to the second terminal device in the case where a sixth condition or a seventh condition is satisfied, and a third condition, a fourth condition, and a fifth condition are all satisfied.

The sixth condition is that a signal quality corresponding to the first sidelink information is greater than a third threshold.

The seventh condition is that the signal quality corresponding to the first sidelink information is greater than a signal quality corresponding to the second sidelink information, or a sum of the signal quality corresponding to the second sidelink information and a fourth threshold.

The third condition is that the transmission resource indicated by the second sidelink information is overlapped with the transmission resource indicated by the first sidelink information.

The fourth condition is that a priority indicated by the second sidelink information is higher than a priority indicated by the first sidelink information.

The fifth condition is that a spatial-domain transmission filter used by the first terminal device to receive the first sidelink information and a spatial-domain transmission filter used by the first terminal device to receive the second sidelink information both satisfy a predetermined condition.

In some embodiments, the signal quality corresponding to the first sidelink information refers to a signal quality of a PSCCH corresponding to the first sidelink information, or a signal quality of a PSSCH scheduled by the PSCCH. The PSCCH corresponding to the first sidelink information may be understood as a PSCCH carrying the first sidelink information. In some embodiments, the signal quality corresponding to the second sidelink information refers to a signal quality of a PSCCH corresponding to the second sidelink information, or a signal quality of a PSSCH scheduled by the PSCCH. The PSCCH corresponding to the second sidelink information may be understood as a PSCCH carrying the second sidelink information. In some embodiments, the signal quality refers to an RSRP or an SL-RSRP.

In some embodiments, at least one of the first threshold, the second threshold, the third threshold, or the fourth threshold is configured by a network, pre-configured, or specified in a standard, or depends on the implementation of the terminal device.

In some embodiments, the transmission resource indicated by the first sidelink information refers to a reserved transmission resource indicated by the first sidelink information, and the transmission resource indicated by the second sidelink information refers to a reserved transmission resource indicated by the second sidelink information. For a specific method for indicating the reserved transmission resource through the sidelink control information, reference may be made to the above description, which will not be repeated herein.

In some embodiments, the priority is represented by a priority value. Exemplarily, a smaller priority value indicates a higher priority. In this case, the priority indicated by the second sidelink information being higher than the priority indicated by the first sidelink information means that the priority value indicated by the second sidelink information is less than the priority value indicated by the first sidelink information. Exemplarily, a larger priority value indicates a higher priority. In this case, the priority indicated by the second sidelink information being higher than the priority indicated by the first sidelink information means that the priority value indicated by the second sidelink information is greater than the priority value indicated by the first sidelink information.

In some embodiments, the fifth condition includes one of the following items:
the spatial-domain transmission filter for receiving the first sidelink information is the same as the spatial-domain transmission filter for receiving the second sidelink information;
the spatial-domain transmission filter for receiving the first sidelink information covers the spatial-domain transmission filter for receiving the second sidelink information; or
the spatial-domain transmission filter for receiving the second sidelink information covers the spatial-domain transmission filter for receiving the first sidelink information.

Exemplarily, as illustrated in FIG. 15, UE B transmits SCI 1 and UE C transmits SCI 2. UE A detects the two pieces of SCI, and receives SCI 1 and SCI 2 using the same receiver beam. UE A corresponds to the first terminal device described above, UE B corresponds to the second terminal device described above, and UE C corresponds to the third terminal device described above. UE A determines that the reserved transmission resources indicated by the two pieces of SCI are overlapped with each other and the priority indicated by SCI 1 is lower than the priority indicated by SCI 2.

In the case where UE A is a receiver of UE B, and an RSRP of a PSCCH carrying SCI 2 or an RSRP of a PSSCH scheduled by the PSCCH is higher than a threshold configured by a network, or the RSRP of the PSCCH carrying SCI 2 or the RSRP of the PSSCH scheduled by the PSCCH is higher than a sum of an RSRP of a PSCCH carrying SCI 1 or an RSRP of a PSSCH scheduled by the PSCCH and a threshold configured by a network, UE A transmits a resource conflict indication to UE B, and UE B triggers resource reselection to avoid a resource conflict, i.e., reselects the reserved resource indicated by SCI 1. In this way, in the case where UE A is the receiver of UE B, UE A transmits, and UE A senses sidelink control information with a higher signal quality transmitted by other terminal devices and the transmission from UE B has a lower priority, the resource conflict indication to UE B to instruct UE B to perform resource reselection, such that strong interference from other terminal devices when UE A receives the data transmitted by UE B is avoided, and data having a high priority is transmitted preferentially.

In the case where UE A is a receiver of UE C, and an RSRP of a PSCCH carrying SCI 1 or an RSRP of a PSSCH scheduled by the PSCCH is higher than a threshold configured by a network, or the RSRP of the PSCCH carrying SCI 1 or the RSRP of the PSSCH scheduled by the PSCCH is higher than a sum of an RSRP of a PSCCH carrying SCI 2 or an RSRP of a PSSCH scheduled by the PSCCH and a threshold configured by a network, UE A transmits a resource conflict indication to UE B, and UE B triggers resource reselection to avoid a resource conflict, i.e., reselects the reserved resource indicated by SCI 1. In this way, in the case where UE A is the receiver of UE C, UE A transmits, and UE A senses sidelink control information with a higher signal quality transmitted by UE B and the transmission from UE B has a lower priority, the resource conflict indication to UE B to instruct UE B to perform resource reselection, such that strong interference from UE B when UE A receives the data from UE C is avoided, and data having a high priority is transmitted preferentially.

According to the technical solutions in the embodiments of the present disclosure, for an SL communication system, in response to determining a resource conflict based on a spatial-domain transmission filter, a first terminal device transmits, to a second terminal device, information used to instruct to perform resource reselection. In this way, the transmission and reception of beams is combined with the resource selection mechanism based on inter-terminal coordination, such that the existing resource selection mechanism based on inter-terminal coordination is applicable to high-frequency communications, such that resource conflicts between terminals operating at high frequencies are effectively avoided, and the communication reliability is improved.

The following embodiments are apparatus embodiments of the present disclosure that are used to implement the method embodiments of the present disclosure. For details that are not disclosed in the apparatus embodiments of the present disclosure, reference may be made to the method embodiments of the present disclosure.

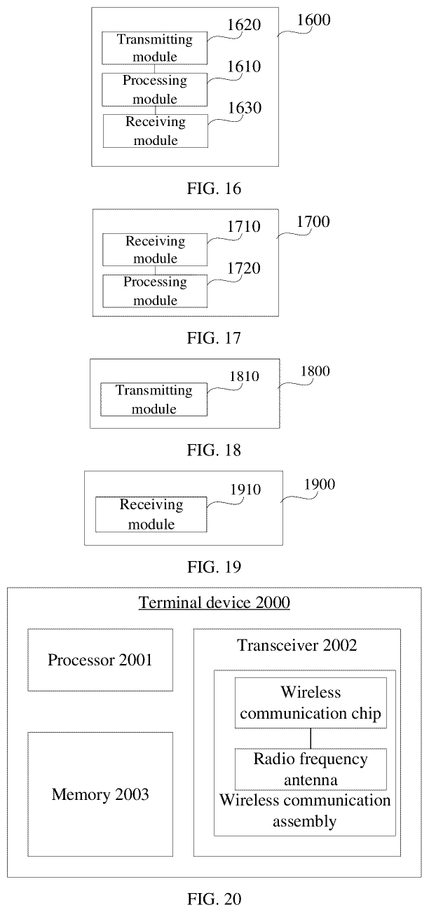

FIG. 16 is a block diagram of an apparatus for resource selection based on inter-terminal coordination according to some embodiments of the present disclosure is illustrated. The apparatus has functions for implementing the method embodiments implemented by the first node, and the functions may be implemented by hardware, or by hardware executing corresponding software. The apparatus may be the first terminal device described above, or may be provided in the first terminal device. As illustrated in FIG. 16, the apparatus 1600 includes: a processing module 1610 and a transmitting module 1620.

The processing module 1610 is configured to determine a resource set based on a spatial-domain transmission filter; and
the transmitting module 1620, configured to transmit first information to a second terminal device, wherein the first information is used to indicate the resource set.

In some embodiments, the spatial-domain transmission filter is a spatial-domain transmission filter used by a first terminal device for reception.

In some embodiments, as illustrated in FIG. 16, the apparatus 1600 further includes:
a receiving module 1630, configured to receive second information from the second terminal device, wherein the second information is used to trigger or request a first terminal device to determine the resource set;
wherein the processing module 1610 is further configured to determine the spatial-domain transmission filter based on the second information.

In some embodiments, the spatial-domain transmission filter is a spatial-domain transmission filter used by the first terminal device to receive the second information.

In some embodiments, the processing module 1610 is configured to determine the spatial-domain transmission filter based on a first indicator field in the second information, wherein the first indicator field is used to indicate at least one spatial-domain transmission filter used by the second terminal device for transmission.

In some embodiments, the spatial-domain transmission filter is determined by a first terminal device autonomously.

In some embodiments, the resource set includes resources suitable for use by the second terminal device; and
the processing module 1610 is configured to:
initialize the resource set, wherein the resource set includes available resources within a resource selection window; and
acquire a post-exclusion resource set by performing resource exclusion on the resource set based on sensed first sidelink control information,
wherein the sensed first sidelink control information includes at least one of: first sidelink control information received by the spatial-domain transmission filter, or first sidelink control information received omnidirectionally.

In some embodiments, the processing module 1610 is configured to:
determine a signal quality threshold table corresponding to the spatial-domain transmission filter based on a correspondence between spatial-domain transmission filters and signal quality threshold tables;
determine a signal quality threshold in the signal quality threshold table corresponding to the spatial-domain transmission filter based on a first priority and a priority indicated by the first sidelink control information received by the spatial-domain transmission filter; and
perform the resource exclusion on the resource set based on the first sidelink control information received by the spatial-domain transmission filter in a case where a signal quality corresponding to the first sidelink control information received by the spatial-domain transmission filter is greater than the signal quality threshold.

In some embodiments, the resource set includes resources unsuitable for use by the second terminal device; and
in a case where a signal quality corresponding to sensed first sidelink control information is greater than a signal quality threshold, the resource set includes resources indicated by the sensed first sidelink control information,
wherein the sensed first sidelink control information includes at least one of: first sidelink control information received by the spatial-domain transmission filter, or first sidelink control information received omnidirectionally.

In some embodiments, the resource set includes resources unsuitable for use by the second terminal device; and
in a case where a signal quality corresponding to sensed first sidelink control information is less than a signal quality threshold, and a first terminal device is a receiver of a physical sidelink shared channel (PSSCH) scheduled by a physical sidelink control channel (PSCCH) corresponding to the sensed first sidelink control information, the resource set includes resources indicated by the sensed first sidelink control information,
wherein the sensed first sidelink control information includes at least one of: first sidelink control information received by the spatial-domain transmission filter, or first sidelink control information received omnidirectionally.

In some embodiments, the processing module 1610 is further configured to:
determine a signal quality threshold table corresponding to the spatial-domain transmission filter based on a correspondence between spatial-domain transmission filters and signal quality threshold tables; and
determine the signal quality threshold in the signal quality threshold table corresponding to the spatial-domain transmission filter based on a priority indicated by the first sidelink control information received by the spatial-domain transmission filter.

In some embodiments, the first information is used to indicate at least one resource set.

In some embodiments, the first information is further used to indicate a spatial-domain transmission filter used by the second terminal device for transmission.

FIG. 17 is a block diagram of an apparatus for resource selection based on inter-terminal coordination according to some embodiments of the present disclosure is illustrated. The apparatus has functions for implementing the method embodiments implemented by the second node, and the functions may be implemented by hardware, or by hardware executing corresponding software. The apparatus may be the second terminal device described above, or may be provided in the second terminal device. As illustrated in FIG. 17, the apparatus 1700 includes: a receiving module 1710 and a processing module 1720.

The receiving module 1710 is configured to receive first information from a first terminal device, wherein the first information is used to indicate a resource set determined by the first terminal device based on a spatial-domain transmission filter; and

the processing module 1720 is configured to determine a transmission resource based on the resource set.

In some embodiments, the first information is used to indicate at least one resource set.

In some embodiments, the first information is further used to indicate a spatial-domain transmission filter used by a second terminal device for transmission.

In some embodiments, the processing module 1720 is further configured to determine, based on the first information, at least one resource set and a spatial-domain transmission filter used by a second terminal device for transmission corresponding to the at least one resource set.

In some embodiments, a resource for a second terminal device to transmit data using a first spatial-domain transmission filter is determined based on a resource set corresponding to the first spatial-domain transmission filter in the resource set indicated by the first information.

In some embodiments, the resource set includes resources suitable for use by a second terminal device or resources unsuitable for use by the second terminal device.

FIG. 18 is a block diagram of an apparatus for resource selection based on inter-terminal coordination according to some embodiments of the present disclosure is illustrated. The apparatus has functions for implementing the method embodiments implemented by the first node, and the functions may be implemented by hardware, or by hardware executing corresponding software. The apparatus may be the first terminal device described above, or may be provided in the first terminal device. As illustrated in FIG. 18, the apparatus 1800 includes a transmitting module 1810.

The transmitting module 1810 is configured to transmit first indication information to a second terminal device in a case where a resource conflict is determined based on a spatial-domain transmission filter, wherein the first indication information is used to instruct the second terminal device to perform resource reselection.

In some embodiments, a first terminal device is a receiver of data from the second terminal device, and the first terminal device receives first sidelink information and second sidelink information, wherein the first sidelink information is sidelink control information transmitted by the second terminal device to indicate a transmission resource, and the second sidelink information is sidelink control information transmitted by a third terminal device to indicate the transmission resource; and
the first terminal device determines a resource conflict and transmits the first indication information to the second terminal device in a case where a first condition or a second condition is satisfied, and a third condition, a fourth condition, and a fifth condition are all satisfied; wherein
the first condition is that a signal quality corresponding to the second sidelink information is greater than a first threshold;
the second condition is that the signal quality corresponding to the second sidelink information is greater than a signal quality corresponding to the first sidelink information or a sum of the signal quality corresponding to the first sidelink information and a second threshold;
the third condition is that the transmission resource indicated by the second sidelink information is overlapped with the transmission resource indicated by the first sidelink information;
the fourth condition is that a priority indicated by the second sidelink information is higher than a priority indicated by the first sidelink information; and
the fifth condition is that a spatial-domain transmission filter used by the first terminal device to receive the first sidelink information and a spatial-domain transmission filter used by the first terminal device to receive the second sidelink information both satisfy a predefined condition.

In some embodiments, a first terminal device is a receiver of data from a third terminal device, and the first terminal device receives first sidelink information and second sidelink information, wherein the first sidelink information is sidelink control information transmitted by the second terminal device to indicate a transmission resource, and the second sidelink information is sidelink control information transmitted by the third terminal device to indicate the transmission resource; and
the first terminal device determines a resource conflict and transmits the first indication information to the second terminal device in a case where a sixth condition or a seventh condition is satisfied, and a third condition, a fourth condition, and a fifth condition are all satisfied; wherein
the sixth condition is that a signal quality corresponding to the first sidelink information is greater than a third threshold;
the seventh condition is that the signal quality corresponding to the first sidelink information is greater than a signal quality corresponding to the second sidelink information or a sum of the signal quality corresponding to the second sidelink information and a fourth threshold;
the third condition is that the transmission resource indicated by the second sidelink information is overlapped with the transmission resource indicated by the first sidelink information;
the fourth condition is that a priority indicated by the second sidelink information is higher than a priority indicated by the first sidelink information; and
the fifth condition is that a spatial-domain transmission filter used by the first terminal device to receive the first sidelink information and a spatial-domain transmission filter used by the first terminal device to receive the second sidelink information both satisfy a predefined condition.

In some embodiments, the fifth condition includes one of the following items:
the spatial-domain transmission filter for receiving the first sidelink information is the same as the spatial-domain transmission filter for receiving the second sidelink information;
the spatial-domain transmission filter for receiving the first sidelink information covers the spatial-domain transmission filter for receiving the second sidelink information; or
the spatial-domain transmission filter for receiving the second sidelink information covers the spatial-domain transmission filter for receiving the first sidelink information.

FIG. 19 is a block diagram of an apparatus for resource selection based on inter-terminal coordination according to some embodiments of the present disclosure is illustrated. The apparatus has functions for implementing the method embodiments implemented by the second node, and the functions may be implemented by hardware, or by hardware executing corresponding software. The apparatus may be the second terminal device described above, or may be provided in the second terminal device. As illustrated in FIG. 19, the apparatus 1900 includes: a receiving module 1910.

The receiving module 1910 is configured to receive first indication information from a first terminal device in a case where a resource conflict is determined based on a spatial-domain transmission filter, wherein the first indication information is used to instruct a second terminal device to perform resource reselection.

It should be noted that when implementing the functions of the apparatus according to the above embodiments, the division of the various functional modules is merely exemplary. In practical applications, the above functions may be assigned to different functional modules according to actual needs, i.e., the content structure of the device can be divided into different functional modules to accomplish all or part of the above functions.

With regard to the apparatus in the above embodiments, the specific mode in which each module performs the operation has been described in detail in the embodiments related to the method and will not be described in detail herein.

FIG. 20 is a schematic structural diagram of a terminal device according to some embodiments of the present disclosure is illustrated. The terminal device 2000 includes: a processor 2001, a transceiver 2002, and a memory 2003.

The processor 2001 may include one or more processing cores, and the processor 2001 executes various functional applications and performs information processing by running software programs and modules.

The transceiver 2002 may include a receiver and a transmitter, which are practiced, for example, as the same wireless communication assembly that includes a wireless communication chip and a radio frequency antenna.

The memory 2003 may be connected to the processor 2001 and the transceiver 2002.

The memory 2003 may be configured to store one or more computer programs loaded and run by the processor, and the processor 2001 is configured to load and run the one or more computer programs to perform the processes in the above method embodiments.

In some embodiments, the terminal device is the first terminal device described above, the processor 2001 is configured to determine a resource set based on a spatial-domain transmission filter; and the transceiver 2002 is configured to transmit first information to a second terminal device, wherein the first information is used to indicate the resource set.

In some embodiments, the terminal device is the second terminal device described above, the transceiver 2002 is configured to receive first information from a first terminal device, wherein the first information is used to indicate a resource set from the first terminal device based on a spatial-domain transmission filter; and the processor 2001 is configured to determine a transmission resource based on the resource set.

In some embodiments, the terminal device is the first terminal device described above, and the transceiver 2002 is configured to transmit first indication information to a second terminal device in the case where a resource conflict is determined based on a spatial-domain transmission filter, wherein the first indication information is used to instruct the second terminal device to perform resource reselection.

In some embodiments, the terminal device is the second terminal device described above, and the transceiver 2002 is configured to receive first indication information from a first terminal device in the case where a resource conflict is determined based on a spatial-domain transmission filter, where the first indication information is used to instruct the second terminal device to perform resource reselection.

For details not specified in the embodiments, reference is made to the foregoing embodiments, which are not repeated herein.

In addition, the memory may be implemented by any type or combination of volatile or non-volatile storage devices, including, but not limited to: a magnetic or optical disc, an electrically erasable programmable read-only memory, an erasable programmable read-only memory, a static random-access memory, a read-only memory (ROM), a magnetic memory, a flash memory, and a programmable read-only memory.

The embodiments of the present disclosure further provide a computer-readable storage medium storing one or more computer programs therein. The one or more computer programs, when loaded and run by a processor, cause the processor to perform the method for resource reselection described above or the method for data transmission described above. In some embodiments, the computer-readable storage medium includes: a ROM, a random-access memory (RAM), a solid state drive (SSD), an optical disk, etc. The RAM includes a resistance random-access memory (ReRAM) and a dynamic random access memory (DRAM).

The embodiments of the present disclosure further provide a chip including programmable logic circuitry and/or one or more program instructions. The chip, when running, is caused to perform the method for resource reselection described above or the method for data transmission described above.

The embodiments of the present disclosure further provide a computer program product. The computer program product includes at least one computer instruction stored in a computer-readable storage medium. The at least one computer instruction, when read from the computer-readable storage medium and executed by a processor, causes the processor to perform the method for resource reselection described above or the method for data transmission described above.

It should be understood that the term “indication” mentioned in the embodiments of the present disclosure is a direct indication, an indirect indication, or an indication that there is an association relationship. For example, A indicates B, which may mean that A indicates B directly, e.g., B may be acquired by A; or that A indicates B indirectly, e.g., A indicates C by which B may be acquired; or that an association relationship is present between A and B.

In the description of the embodiments of the present disclosure, the term “correspond” indicates a direct or indirect corresponding relationship between two items, or indicates an associated relationship between the two items; and also indicates relationships such as indicating and being indicated, or configuring and being configured.

In some embodiments of the present disclosure, the term “predefined” is implemented by pre-storing corresponding codes, tables, or other means that may be defined to indicate related information in devices (including, for example, terminal devices and network devices), and the present disclosure does not limit the specific implementation thereof. For example, “predefined” refers to “defined” in a protocol.

In some embodiments of the present disclosure, the “protocol” refers to a standard protocol in the communication field including, for example, the LTE protocol, the NR protocol, and related protocols applied in future communication systems, which is not limited in the present disclosure.

The mentioned term “a plurality of” herein means two or more. The term “and/or” describes the association relationship between the associated objects, and indicates that three relationships may be present. For example, the phrase “A and/or B” means (A), (B), or (A and B). The symbol “/” generally indicates an “or” relationship between the associated objects.

Reference herein to “greater than or equal to” may indicate greater than or equal to or just greater than, and “less than or equal to” may indicate less than or equal to or just less than.

In addition, serial numbers of the processes described herein only show an exemplary possible sequence of performing the processes. In some other embodiments, the processes may also be performed out of the numbering sequence, for example, two processes with different serial numbers are performed simultaneously, or two processes with different serial numbers are performed in a reverse order to the illustrated sequence, which is not limited in the present disclosure.

Those skilled in the art should understand that in one or more of the above embodiments, the functions described in the embodiments of the present disclosure may be implemented in hardware, software, firmware, or any combination thereof. The functions, when implemented in software, may be stored in a computer-readable medium or transmitted as one or more instructions or codes on a computer-readable medium. The computer-readable medium includes a computer storage medium and a communication medium, where the communication medium includes any medium that facilitates the transfer of a computer program from one place to another. The storage medium is any available medium that is accessible by a general-purpose or special-purpose computer.

Described above are merely exemplary embodiments of the present disclosure and are not intended to limit the present disclosure. Any modifications, equivalent substitutions, improvements, and the like, made within the spirit and principle of the present disclosure should fall within the protection scope of the present disclosure.

1. A method for resource selection based on inter-terminal coordination, performed by a first terminal device, the method comprising:
determining a resource set based on a spatial-domain transmission filter; and
transmitting first information to a second terminal device, wherein the first information is used to indicate the resource set.

2. The method according to claim 1, wherein the spatial-domain transmission filter is a spatial-domain transmission filter used by the first terminal device for reception.

3. The method according to claim 1, further comprising:
receiving second information from the second terminal device, wherein the second information is used to trigger or request the first terminal device to determine the resource set; and
determining the spatial-domain transmission filter based on the second information.

4. The method according to claim 3, wherein the spatial-domain transmission filter is a spatial-domain transmission filter used by the first terminal device to receive the second information.

5. The method according to claim 3, wherein determining the spatial-domain transmission filter based on the second information comprises:
determining the spatial-domain transmission filter based on a first indicator field in the second information, wherein the first indicator field is used to indicate at least one spatial-domain transmission filter used by the second terminal device for transmission.

6. The method according to claim 1, wherein the spatial-domain transmission filter is determined by the first terminal device autonomously.

7. The method according to claim 1, wherein
the resource set comprises resources suitable for use by the second terminal device; and
determining the resource set based on the spatial-domain transmission filter comprises:
initializing the resource set, wherein the resource set comprises available resources within a resource selection window; and
acquiring a post-exclusion resource set by performing resource exclusion on the resource set based on sensed first sidelink control information, wherein the sensed first sidelink control information comprises at least one of: first sidelink control information received by the spatial-domain transmission filter, or first sidelink control information received omnidirectionally.

8. The method according to claim 7, wherein performing the resource exclusion on the resource set based on the sensed first sidelink control information comprises:
determining a signal quality threshold table corresponding to the spatial-domain transmission filter based on a correspondence between spatial-domain transmission filters and signal quality threshold tables;
determining a signal quality threshold in the signal quality threshold table corresponding to the spatial-domain transmission filter based on a first priority and a priority indicated by the first sidelink control information received by the spatial-domain transmission filter; and
performing the resource exclusion on the resource set based on the first sidelink control information received by the spatial-domain transmission filter in a case where a signal quality corresponding to the first sidelink control information received by the spatial-domain transmission filter is greater than the signal quality threshold.

9. The method according to claim 1, wherein the resource set comprises resources unsuitable for use by the second terminal device; and in a case where a signal quality corresponding to sensed first sidelink control information is greater than a signal quality threshold, the resource set comprises resources indicated by the sensed first sidelink control information, wherein the sensed first sidelink control information comprises at least one of: first sidelink control information received by the spatial-domain transmission filter, or first sidelink control information received omnidirectionally.

10. The method according to claim 1, wherein the resource set comprises resources unsuitable for use by the second terminal device; and in a case where a signal quality corresponding to sensed first sidelink control information is less than a signal quality threshold, and the first terminal device is a receiver of a physical sidelink shared channel (PSSCH) scheduled by a physical sidelink control channel (PSCCH) corresponding to the sensed first sidelink control information, the resource set comprises resources indicated by the sensed first sidelink control information, wherein the sensed first sidelink control information comprises at least one of: first sidelink control information received by the spatial-domain transmission filter, or first sidelink control information received omnidirectionally.

11. The method according to claim 9, further comprising:
determining a signal quality threshold table corresponding to the spatial-domain transmission filter based on a correspondence between spatial-domain transmission filters and signal quality threshold tables; and
determining the signal quality threshold in the signal quality threshold table corresponding to the spatial-domain transmission filter based on a priority indicated by the first sidelink control information received by the spatial-domain transmission filter.

12. The method according to claim 1, wherein the first information is used to indicate at least one resource set.

13. The method according to claim 1, wherein the first information is further used to indicate a spatial-domain transmission filter used by the second terminal device for transmission.

14. A terminal device, comprising: a processor and a memory storing one or more computer programs, wherein the processor is configured to load and run the one or more computer programs to cause the terminal device to:
determine a resource set based on a spatial-domain transmission filter; and
transmit first information to a second terminal device, wherein the first information is used to indicate the resource set.

15. A terminal device, comprising: a processor and a memory storing one or more computer programs, wherein the processor is configured to load and run the one or more computer programs to cause the terminal device to:
receive first information from a first terminal device, wherein the first information is used to indicate a resource set determined by the first terminal device based on a spatial-domain transmission filter; and
determine a transmission resource based on the resource set.

16. The terminal device according to claim 15, wherein the first information is used to indicate at least one resource set.

17. The terminal device according to claim 15, wherein the first information is further used to indicate a spatial-domain transmission filter used by the terminal device for transmission.

18. The terminal device according to claim 15, wherein the processor is configured to load and run the one or more computer programs to cause the terminal device to:
determine, based on the first information, at least one resource set and a spatial-domain transmission filter used by the terminal device for transmission corresponding to the at least one resource set.

19. The terminal device according to claim 15, wherein a resource for the terminal device to transmit data using a first spatial-domain transmission filter is determined based on a resource set corresponding to the first spatial-domain transmission filter in the resource set indicated by the first information.

20. The terminal device according to claim 15, wherein the resource set comprises resources suitable for use by the terminal device or resources unsuitable for use by the terminal device.
